(19) United States
(12) Patent Application Publication
(10) Pub. No.: US 2016/0363470 A1
(43) Pub. Date: Dec. 15, 2016

(54) Airflow Sensor and Airflow Detecting Module

(71) Applicant: Sunonwealth Electric Machine Industry Co., Ltd., Kaohsiung City (TW)

(72) Inventors: Alex Horng, Kaohsiung City (TW); Shit-Chin Wu, Kaohsiung City (TW); Tsung-Hsin Cheng, Kaohsiung City (TW)

(21) Appl. No.: 15/169,793

(22) Filed: Jun. 1, 2016

(30) Foreign Application Priority Data
Jun. 9, 2015 (TW) 104118630

(51) Int. Cl. G01F 1/115; F24F 11/02; F24F 11/00

(52) U.S. Cl. CPC G01F 1/115; F24F 11/001; F24F 11/02; F24F 2011/0038

(57) ABSTRACT

An airflow sensor is disclosed to overcome the problem of having an undetectable wind speed range. The airflow sensor may include a frame and an impeller. The frame includes a rotation detector. The impeller is rotatably coupled with the frame and includes a plurality of blades and a rotating member. The rotation detector generates a detection signal according to a rotational cycle of the rotating member. Moreover, an airflow detecting module is further provided to overcome said problem.

### CROSS REFERENCE TO RELATED APPLICATIONS

The application claims the benefit of Taiwan application serial No. 104118630, filed on Jun. 9, 2015, the subject matter of which is incorporated herein by reference.

### BACKGROUND OF THE INVENTION

### 1. Field of the Invention

The present invention generally relates to a sensor and a detecting module and, more particularly, to an airflow sensor and an airflow detecting module.

### 2. Description of the Related Art

A fan or a ventilation system can be used to regulate the temperature via the flow of air. As an example of the ventilation system, the cooled air can be guided into a plurality of air channels and then guided to an indoor space via a plurality of air outlets for regulating the temperature in the indoor space and for the ventilation purposes. However, different air outlets may have different throughputs which lead to different temperature regulating efficiencies. In order to observe the throughput of an air outlet, a little strip of paper can be hanged in front of the air outlet such that the paper will flicker as the air flows through it. In this manner, the throughput of the air outlet can be visually observed by the intensity of the flickering motion. However, this mechanism requires visual observations, which is difficult to provide a precise determination on the throughput of the air outlet and also difficult to achieve a centralized supervision and management on the temperature regulating efficiency.

To overcome the above problem, a detection apparatus was provided to automatically detect the wind speed. The detection apparatus may include, for example, a baffle between each adjacent air channel. The baffle can pivot at an angle when the wind blows open the baffle. The angle can be detected by a sensor (such as a photo sensor) and the detected angle information may be sent to a device which calculates the exact wind speed blowing onto the baffle. An embodiment of such a detection apparatus may be seen in Taiwan Patent Publication No. 201111787.

In the above structure, however, the intensity of the airflow can be detected only when the baffle is pushed open by the flow of air. If the flow of air is too weak to push the baffle open, the baffle will not pivot at all and it will be impossible to detect the intensity of the airflow. To the contrary, when the flow of air is so strong that the baffle is pushed to have already pivoted in a full extent, the wind speed that can be detected has reached a maximum value. In this regard, no matter how much stronger the flow of air has become, it will be no longer possible to detect the instant wind speed since the wind speed has increased beyond the maximal detectable range of the detection apparatus.

In light of this, it is necessary to improve the conventional detection apparatus.

### SUMMARY OF THE INVENTION

It is therefore the objective of this invention to provide an airflow sensor that can precisely detect the airflow information.

In an embodiment, an airflow sensor including a frame and an impeller is disclosed. The frame includes a rotation detector. The impeller is rotatably coupled with the frame and includes a plurality of blades and a rotating member. The rotation detector generates a detection signal according to a rotational cycle of the rotating member.

In another embodiment, an airflow detecting module including a frame, an impeller and a processing unit is disclosed. The frame is mounted in an air channel and includes a rotation detector. The impeller is rotatably coupled with the frame and includes a plurality of blades and a rotating member. The rotation detector generates a detection signal according to a rotational cycle of the rotating member. The processing unit is electrically connected to the rotation detector of the frame and generates airflow information according to the detection signal.

In a form shown, the rotation detector may be aligned with the rotating member.

In the form shown, the rotation detector may be a magnetic inducing element, and the rotating member may be a magnetic member.

In the form shown, the magnetic inducing element may be a Hall element.

In the form shown, the magnetic inducing element may be embedded in or indirectly mounted in the frame.

In the form shown, the rotation detector may be a proximity switch, and the rotating member may be a conducting member.

In the form shown, the proximity switch may be mounted in the frame.

In the form shown, the rotation detector may be a photo sensor, and the rotating member is provided with at least one strip of reflective material.

In the form shown, the photo sensor may be a photo transceiver.

In the form shown, the frame may include a baffle that prevents disengagement of the impeller.

In the form shown, the processing unit may include a power supplier and a signal converter that are electrically connected to the rotation detector.

In the form shown, the processing unit may include a human machine interface electrically connected to the signal converter.

In the form shown, the processing unit may include a transceiver electrically connected to the signal converter.

In the form shown, the impeller may have a longitudinal axis extending parallel to an extension direction of the air channel.

In the form shown, the impeller may be of an axial-flow type or a centrifugal type.

In the form shown, the rotation detector may be a photo coupler, and the rotating member may include at least one light-permeable portion.

In the form shown, the frame includes a circuit board, and the rotation detector is mounted on the circuit board. The circuit board may be integrally formed with the frame, and the circuit board may form a base of the frame.

In the form shown, the frame may include a plurality of ribs.

In the above airflow sensor and the airflow detecting module, when the impeller is driven to rotate under the flow of air, the rotation detector may generate the detection signal according to the rotational cycle of the rotating member. In this regard, the processing unit is able to calculate the airflow information according to the detection signal outputted by the rotation detector. In this mechanism, the intensity of the airflow and the rotational cycle of the impeller can be generated via the relative rotation between the rotating member and the rotation detector. Thus, the precise flow information of the airflow can be obtained, and the intensity of the airflow can be detected via the flow information. Advantageously, the disadvantage of having an undetectable wind speed range of the conventional detection apparatus can be overcome.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a cross sectional view of an airflow sensor according to a first embodiment of the invention.

FIG. 2a is a top view of the airflow sensor of the first embodiment of the invention wherein a rotation detector and a rotating member are provided according to an implementation thereof.

FIG. 2b is a top view of the airflow sensor of the first embodiment of the invention wherein the rotation detector and the rotating member are provided according to another implementation thereof.

FIG. 3 is a cross sectional view of an airflow sensor according to a second embodiment of the invention.

FIG. 4 is a cross sectional view of an airflow sensor according to a third embodiment of the invention.

FIG. 5 is a cross sectional view of an airflow detecting module.

In the various figures of the drawings, the same numerals designate the same or similar parts. Furthermore, when the terms “first”, “second”, “third”, “fourth”, “inner”, “outer”, “top”, “bottom”, “front”, “rear” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

The term “airflow” refers to the air in a flowing state resulting from the difference in temperature or pressure, and can be analyzed in term of the amount or speed of the air, as it can be readily appreciated by the skilled persons.

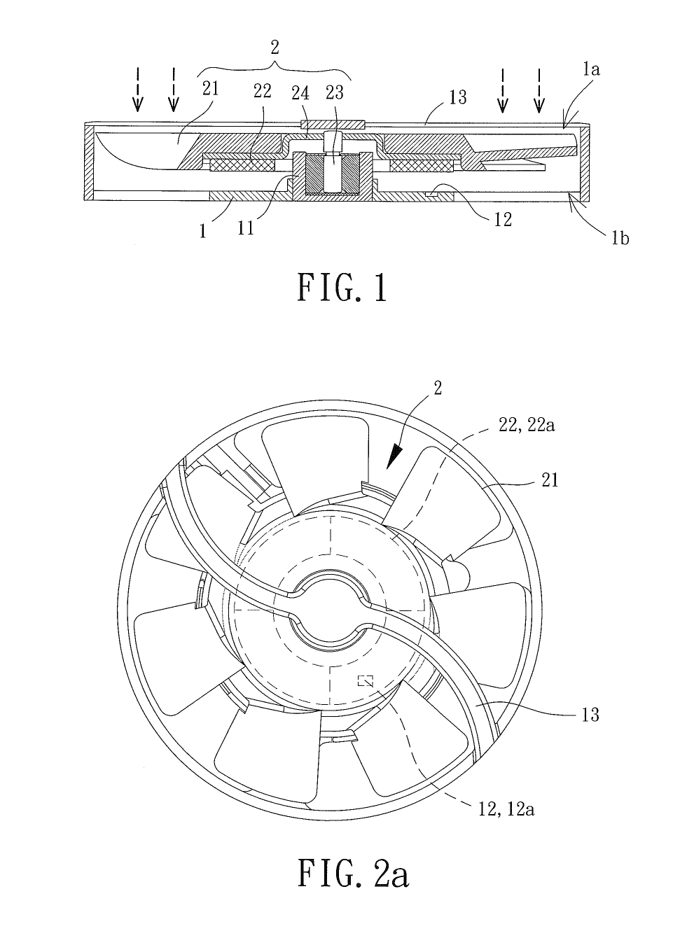

FIG. 1 is a cross sectional view of an airflow sensor according to a first embodiment of the invention. The airflow sensor may include a frame 1 and an impeller 2. The frame 1 may include a shaft tube 11 and a rotation detector 12. The impeller 2 may couple with the shaft tube 11 of the frame 1. The impeller 2 may include a plurality of blades 21 and a rotating member 22. The rotation detector 12 may generate a detection signal, such as a voltage or an electric current, according to the rotational cycle of the rotating member 22.

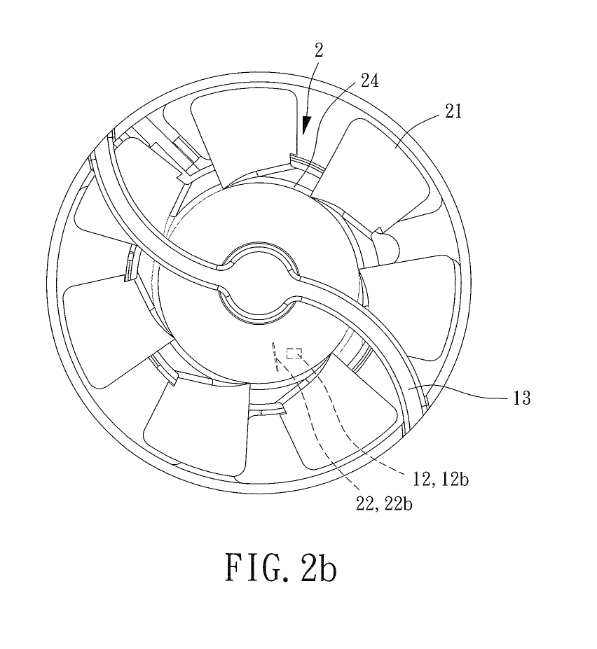

In the embodiment, the frame 1 is in the form of an air-guiding frame. The air-guiding frame may be in a circular form (as shown in FIGS. 2a and 2b) or a rectangular form, so that the air-guiding frame forms an inlet side 1a and an outlet side 1b at which the air is able to flow into and exist from the frame 1. An inner assembly such as a bearing and a retaining plate may be arranged in the shaft tube 11 to provide a stable and smooth rotation of the impeller 2. The rotation detector 12 may be arranged somewhere around the shaft tube 11. For example, the rotation detector 12 may be arranged in an interior of the frame 1, on a surface of the frame 1, or on an element (such as a circuit board) located on the frame 1 for detecting the rotational cycle of the impeller 2. The frame 1 may include a baffle 13 (such as a rib) that prevents the disengagement of the impeller 2. The impeller 2 may be of an axial-flow type or a centrifugal type. The impeller 2 may include a shaft 23 and a hub 24. One end of the shaft 23 may be inserted into the shaft tube 11 and another end of the shaft 23 may couple with the hub 24. The blades 21 may be arranged on an outer periphery of the hub 24. The rotating member 22 may be mounted on the top face, the bottom face or the outer circumferential face of the hub 24. The rotating member 22 is located within a detectable range of the rotation detector 12. For example, the rotating member 22 is aligned with the rotation detector 12. Arrangement of the rotation detector 12 and the rotating member 22 is described later.

For example, as shown in FIG. 2a, the rotation detector 12 may be a magnetic inducing element 12a such as a Hall sensor or a Hall integrated circuit (IC). The magnetic inducing element 12a may be embedded in the frame 1 (as shown in FIG. 1) or may be indirectly mounted on an element (such as the circuit board) located on the frame 1. The rotating member 22 may be a magnetic member 22a, which can be in the form of a plate (as shown in FIG. 1), a ring or a cup. The magnetic member 22a may have a plurality of magnetic poles (such as N and S poles) which is located within the detectable range of the magnetic inducing element 12a. For instance, the magnetic inducing element 12a is located within a projection range of the magnetic member 22a. However, this is not taken as a limited sense. In this arrangement, when the impeller 2 brings the magnetic member 22a to rotate, the magnetic inducing element 12a is able to detect the polarity change of the magnetic field. Accordingly, the flow direction or magnitude of the output current can be adjusted. Thus, when the blades 21 are driven to rotate by the flow of air, the rotational cycle of the impeller 2 can be detected.

Moreover, referring to FIG. 2b, the rotation detector 12 may be a photo sensor 12b such as a photo transceiver. The photo sensor 12b is able to emit light beams onto the hub 24. Accordingly, the rotating member 22 may be provided with at least one strip of reflective material 22b (such as an object having a glossy surface or a mirror that reflects light). The strip of reflective may be arranged in parallel to a longitudinal axis of the hub 24, such that the photo sensor 12b is able to detect whether the hub 24 rotates via the reflection of the light beams. As such, when the strip of reflective material 22b rotates with the impeller 2, the photo sensor 12b is able to detect the reflection of the light beams. Based on this, the flow direction or magnitude of the output current or voltage can be adjusted. In this manner, the rotational cycle and intensity of the airflow can be detected.

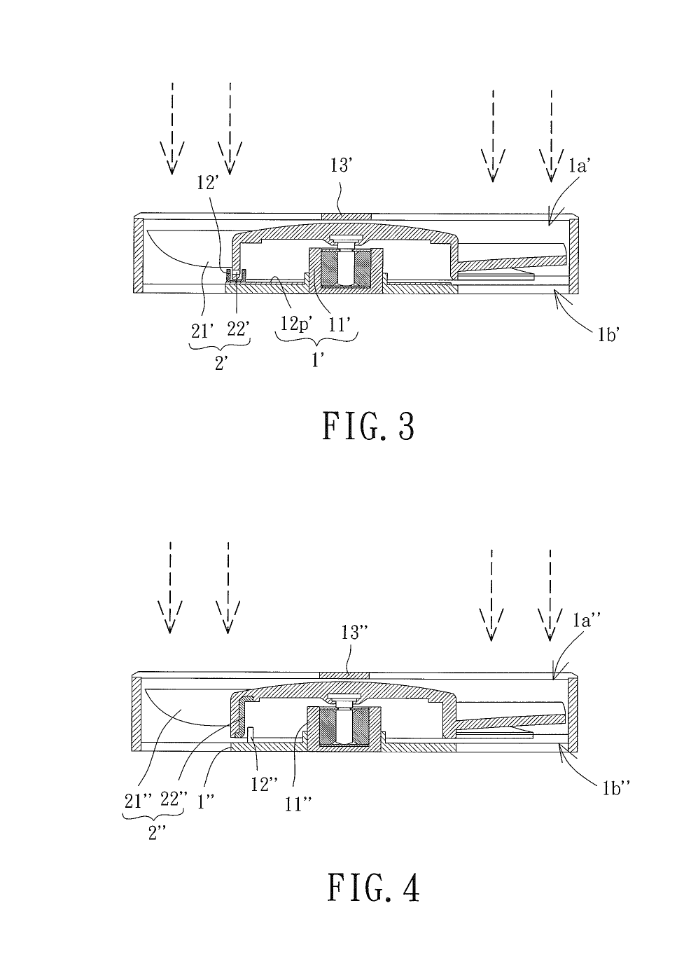

FIG. 3 is a cross sectional view of an airflow sensor according to a second embodiment of the invention. The airflow sensor includes a frame 1′ and an impeller 2′. The frame 1′ may have an inlet side 1a′ and an outlet side 1b′. The frame 1′ may include a shaft tube 11′, a rotation detector 12′, a circuit board 12p′ and a baffle 13′. The rotation detector 12′ may be mounted on the circuit board 12p′. The circuit board 12p′ may be integrally formed with or detachably attached to the frame 1′. Alternatively, the circuit board 12p′ may form a base of the frame 1′. The impeller 2′ is rotatably coupled with the shaft tube 11′ of the frame 1′ and includes a plurality of blades 21′ and a rotating member 22′. In the embodiment, the rotating member 22′ may include at least one light-permeable portion such as at least one through-hole, transparent acrylics or transparent resin. The rotating member 22′ may be mounted on the hub of the impeller 2′. The rotation detector 12′ may be a photo coupler. The photo coupler includes a light-emitting end and a light-receiving end that are respectively located at two sides of the rotating member 22′ during the rotation of the impeller 2′. Thus, the rotation detector 12′ is able to detect the rotational cycle of the impeller 2′ according to whether the light has passed through the light-permeable portion(s).

FIG. 4 is a cross sectional view of an airflow sensor according to a third embodiment of the invention. The airflow sensor includes a frame 1″ and an impeller 2″. The frame 1″ may have an inlet side 1a″ and an outlet side 1b″. The frame 1″ may include a shaft tube 11″, a rotation detector 12″ and a baffle 13″. The impeller 2″ may be rotatably coupled with the shaft tube 11″ of the frame 1″ and includes a plurality of blades 21″ and a rotating member 22″. In the embodiment, the rotation detector 12″ may be an inducing element such as a proximity switch, and the rotating member 22″ may be at least one conducting member such as at least one metal bar. The conducting member may be arranged in parallel to a longitudinal axis of the impeller 2″. In this arrangement, when the impeller 2″ drives the conducting member(s) to rotate, the rotation detector 12″ may detect the polarity change of the electric field. Accordingly, the flow direction or magnitude of the output current can be adjusted, thereby obtaining the rotational cycle and intensity of the airflow.

Based on this, referring to FIGS. 1, 3 and 4, when the impeller 2, 2′, 2″ is driven to rotate under the flow of air, the impeller 2, 2′, 2″ is able to drive the rotating member 22, 22′, 22″ to rotate relative to the rotation detector 12, 12′, 12″. In this regard, the rotation detector 12, 12′, 12″ is able to detect the change in the electricity field, the magnetic field and the light distribution, thereby outputting a detection signal in relation to the rotational cycle of the impeller 2, 2′, 2″ (in a linear or nonlinear relation). Besides, since the rotational cycle of the impeller 2, 2′, 2″ has a certain relationship with the intensity of the airflow (which can be represented by, for example, a transformation equation, a relationship curve or a relationship table), the intensity of the airflow can be calculated based on the output signal of the above rotation detector. Explanation is made as follows but it is not taken as a limited sense.

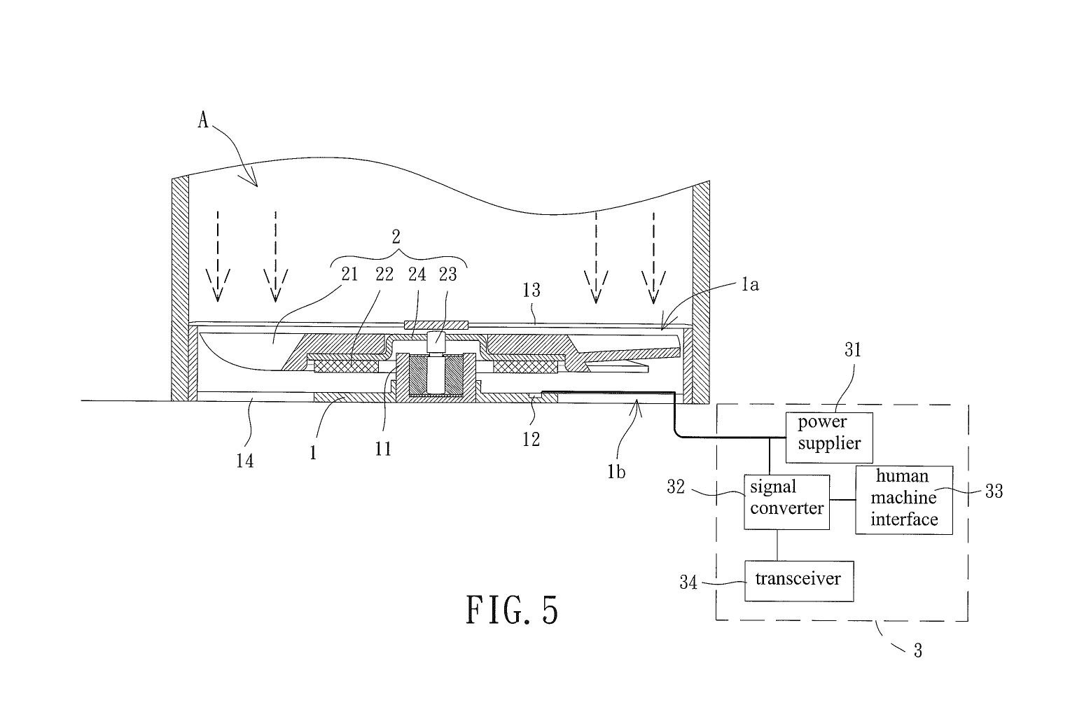

FIG. 5 shows a configuration of an airflow detecting module of the invention. The airflow detecting module may include the above airflow sensor of the first embodiment of the invention and a processing unit 3. Based on this, the frame 1 may be located in an air channel “A.” Specifically, the frame 1 may include a plurality of ribs 14 spaced from each other for smooth passage of the air without seriously affecting the detection accuracy of the airflow information, such as the intensity or speed of the airflow. The impeller 2 (which is of an axial-flow type or a centrifugal type) includes a longitudinal axis extending parallel to the extension direction of the air channel “A.” In this arrangement, the impeller 2 may be driven to rotate under the flow of air. The configuration and arrangement of the impeller 2 is not limited herein. The processing unit 3 may calculate the airflow information according to the detection signal outputted by the rotation detector 12. The airflow information may have a transformation relationship with respect to the detection signal, which may be represented by a transformation equation, a relationship curve or a relationship table according to different applications. The transformation equation, the relationship curve or the relationship table may be used according to different default values or input parameters. It is noted that although the airflow sensor of the first embodiment is used in the airflow detecting module as described above, the other airflow sensor of the second or third embodiment may also be used instead of the one of the first embodiment.

In the embodiment, the processing unit 3 (which is in the form of at least one circuit board or at least one special function integrated circuit) may include a power supplier 31 (such as a voltage regulator or a solar battery) and a signal converter 32 (such as a digital signal processor). The power supplier 31 is electrically connected to the signal converter 32 and the rotation detector 12, and may be arranged inside or outside of the frame 1. The signal converter 32 may receive the detection signal, execute a transformation program, and generate the airflow information according to the detection signal. The airflow information is outputted to an associated system (such as a control system of an air conditioner). Besides, the processing unit 3 may further include a human machine interface 33 (HMI such as a touch screen). The human machine interface 33 may be connected to the signal converter 32 for receiving the control parameters or outputting the airflow information. The human machine interface 33 may be connected to another control system (condominium administration and supervision system) according to the requirement. In addition, the processing unit 3 may further include a transceiver 34 (such as a wireless transceiver) that may be arranged inside or outside of the frame 1 for receiving a control signal from a remote control platform (such as a smart phone or a computer) or for sending the airflow information to the remote control platform. However, this is not taken as a limited sense.

Based on the technique features above, the airflow sensors and the airflow detecting module as presented above have the following characteristics. Specifically, the frame 1, 1′, 1″ may include the rotation detector 12, 12′, 12″, the impeller 2, 2′, 2″ may rotatably couple with the frame 1, 1′, 1″, and the impeller 2, 2′, 2″ include the blades 21, 21′, 21″ and the rotating member 22, 22′, 22″. In this regard, the rotation detector 12, 12′, 12″ outputs the detection signal according to the rotational cycle of the rotating member 22, 22′, 22″. Accordingly, the processing unit 3 generates the airflow information based on the detection signal.

In the above arrangement, when the impeller 2, 2′, 2″ is driven to rotate under the flow of air, the detection signal and the airflow information can be generated via the relative rotation between the rotating member 22, 22′, 22″ and the rotation detector 12, 12′, 12″. As such, the related information of the airflow can be precisely detected without having the disadvantage of the conventional detection apparatus where the intensity of the airflow can no longer be detected once the intensity of the airflow has reached a certain level.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. An airflow sensor comprising:
a frame having a rotation detector; and
an impeller rotatably coupled with the frame and comprising a plurality of blades and a rotating member, wherein the rotation detector generates a detection signal according to a rotational cycle of the rotating member.

2. The airflow sensor as claimed in claim 1, wherein the rotation detector is aligned with the rotating member.

3. The airflow sensor as claimed in claim 1, wherein the rotation detector is a magnetic inducing element, and the rotating member is a magnetic member.

4. The airflow sensor as claimed in claim 3, wherein the magnetic inducing element is a Hall element.

5. The airflow sensor as claimed in claim 3, wherein the magnetic inducing element is embedded in or indirectly mounted in the frame.

6. The airflow sensor as claimed in claim 1, wherein the rotation detector is a proximity switch, and the rotating member is a conducting member.

7. The airflow sensor as claimed in claim 6, wherein the proximity switch is mounted in the frame.

8. The airflow sensor as claimed in claim 1, wherein the rotation detector is a photo sensor, and the rotating member is provided with at least one strip of reflective material.

9. The airflow sensor as claimed in claim 8, wherein the photo sensor is a photo transceiver.

10. The airflow sensor as claimed in claim 1, wherein the rotation detector is a photo coupler, and the rotating member forms at least one light-permeable portion.

11. The airflow sensor as claimed in claim 1, wherein the frame comprises a circuit board, and the rotation detector is mounted on the circuit board.

12. The airflow sensor as claimed in claim 11, wherein the circuit board is integrally formed with the frame.

13. The airflow sensor as claimed in claim 11, wherein the circuit board forms a base of the frame.

14. The airflow sensor as claimed in claim 1, wherein the frame comprises a baffle that prevents disengagement of the impeller.

15. The airflow sensor as claimed in claim 1, wherein the impeller is of an axial-flow type or a centrifugal type.

16. An airflow detecting module comprising:
a frame arranged in an air channel and comprising a rotation detector;
an impeller rotatably coupled with the frame and comprising a plurality of blades and a rotating member, wherein the rotation detector generates a detection signal according to a rotational cycle of the rotating member; and
a processing unit electrically connected to the rotation detector of the frame and generating airflow information according to the detection signal.

17. The airflow detecting module as claimed in claim 16, wherein the rotation detector is aligned with the rotating member.

18. The airflow detecting module as claimed in claim 16, wherein the rotation detector is a magnetic inducing element, and the rotating member is a magnetic member.

19. The airflow detecting module as claimed in claim 18, wherein the magnetic inducing element is a Hall element.

20. The airflow detecting module as claimed in claim 19, wherein the magnetic inducing element is embedded in or indirectly mounted in the frame.

21. The airflow detecting module as claimed in claim 16, wherein the rotation detector is a proximity switch, and the rotating member is a conducting member.

22. The airflow detecting module as claimed in claim 21, wherein the proximity switch is mounted in the frame.

23. The airflow detecting module as claimed in claim 16, wherein the rotation detector is a photo sensor, and the rotating member is provided with at least one strip of reflective material.

24. The airflow detecting module as claimed in claim 23, wherein the photo sensor is a photo transceiver.

25. The airflow detecting module as claimed in claim 16, wherein the processing unit comprises a power supplier and a signal converter that are electrically connected to the rotation detector.

26. The airflow detecting module as claimed in claim 25, wherein the processing unit further comprises a human machine interface electrically connected to the signal converter.

27. The airflow detecting module as claimed in claim 25, wherein the processing unit further comprises a transceiver electrically connected to the signal converter.

28. The airflow detecting module as claimed in claim 16, wherein the impeller has a longitudinal axis extending parallel to an extension direction of the air channel.

29. The airflow detecting module as claimed in claim 28, wherein the impeller is of an axial-flow type or a centrifugal type.

30. The airflow detecting module as claimed in claim 16, wherein the rotation detector is a photo coupler, and the rotating member comprises at least one light-permeable portion.

31. The airflow detecting module as claimed in claim 16, wherein the frame comprises a circuit board, and the rotation detector is mounted on the circuit board.

32. The airflow detecting module as claimed in claim 31, wherein the circuit board is integrally formed with the frame.

33. The airflow detecting module as claimed in claim 31, wherein the circuit board forms a base of the frame.

34. The airflow detecting module as claimed in claim 16, wherein the frame comprises a baffle that prevents disengagement of the impeller.

35. The airflow detecting module as claimed in claim 16, wherein the frame comprises a plurality of ribs.
